(19) United States
(12) Patent Application Publication
(10) Pub. No.: US 2005/0092448 A1
(43) Pub. Date: May 5, 2005

(54) Roll-up blind with safety cord cover

(76) Inventor: Henry Lin, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/697,109

(22) Filed: Oct. 31, 2003

(51) Int. Cl. E06B 9/56

(52) U.S. Cl. 160/291

(57) ABSTRACT

Disclosed is a roll-up blind with safety arrangement. The blind comprises a headrail, a brake mechanism proximate the headrail, a cord having one end passed the brake mechanism to form an operable portion, a shade cloth coupled to the headrail, the shade cloth having a lower end coupled to the other end of the cord, and a plurality of cord covers formed on the shade cloth to cover the other end of the cord. Whereby pulling the operable portion of the cord will cause the shade cloth to wrinkle upwardly and the cord covers to contract together. Most importantly, a dangerous ring will not be formed by the cord and the cord covers in operation. Also, the shade cloth is wrinkled upwardly and the cord covers are contracted together to form aesthetic members in response to drawing up.

### BACKGROUND OF THE INVENTION

1. Field of the Invention

The present invention relates to roll-up blinds and more particularly to a roll-up blind with a safety cord cover.

2. Description of Related Art

Blinds for keeping out light are well known. A conventional roll-up blind 10 is shown in FIG. 1. The blind 10 comprises a shade cloth 11, a headrail 12 coupled to a top of the shade cloth 11, a brake 13 coupled to about one end of the headrail 12, and a cord 14 being operative to pull to lower or lift the shade cloth 11 prior to stopping the shade cloth 11 at a predetermined position by means of the brake 13. The headrail 11 comprises a plurality of rectangular sections 15 stitched together longitudinally. Two spaced holes 16 are formed between any two adjacent sections 15. One ends 17 of the cord 14 pass through the brake 13 prior to disposing vertically and the other ends 18 thereof pass the holes 16 to fasten at the lowest holes 16. Hence, the shade cloth 11 can be drawn up or lowered by pulling either portion of one ends 17 of the cord 14.

A ring will be formed at the other ends 18 when the shade cloth 11 is lowering. Unfortunately, a child may put the ring on his/her neck prior to pulling either portion of one ends 17. As such, the other ends 18 may move up to possibly hang the child. This is not a safe design because there is no safety arrangement provided between the cord 14 and the holes 16. Hence, a need for improvement exists.

### SUMMARY OF THE INVENTION

It is an object of the present invention to provide a roll-up blind with a safety arrangement comprising a headrail, a brake mechanism proximate the headrail, a cord having one end passed the brake mechanism to form an operable portion, a shade cloth coupled to the headrail, the shade cloth having a lower end coupled to the other end of the cord, and a plurality of soft cord covers formed on the shade cloth to cover the other end of the cord. Whereby pulling the operable portion of the cord will cause the shade cloth to wrinkle upwardly and the cord covers to contract together. Most importantly, a dangerous ring will not be formed by the cord and the cord covers in operation. Also, the shade cloth is wrinkled upwardly and the cord covers are contracted together to form aesthetic members in response to drawing up.

In one aspect of the present invention there are further provided a plurality of spaced apart positioning elements formed longitudinally on each cord cover, whereby a lifting or lowering movement of the cord covers by pulling the operable portion of the cord will draw up the positioning elements other than the topmost positioning element toward the topmost positioning element.

In another aspect of the present invention the positioning elements are formed by stitching to the cord cover and the shade cloth so that a lifting or lowering movement of the cord covers is able to move the shade cloth the same.

The above and other objects, features and advantages of the present invention will become apparent from the following detailed description taken with the accompanying drawings.

### BRIEF DESCRIPTION OF THE DRAWINGS

FIG. 1 is a perspective view of a conventional roll-up blind;

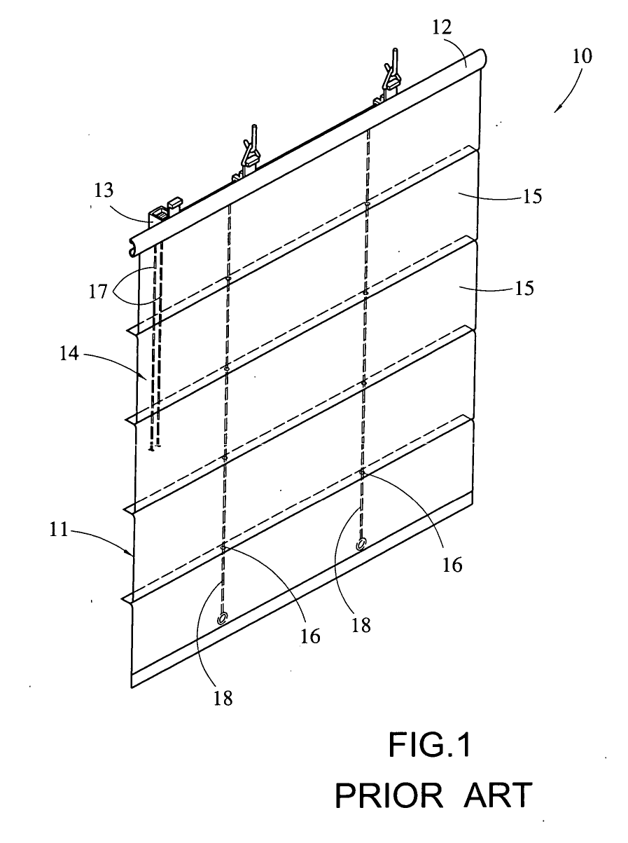

FIG. 2 is a front perspective view of a preferred embodiment of roll-up blind according to the invention;

FIG. 3 is a rear perspective view of the blind shown in FIG. 2, where the shade cloth is being lowered; and

FIG. 4 is another rear perspective view of the blind shown in FIG. 2, where the shade cloth is being drawn up.

### DETAILED DESCRIPTION OF THE PREFERRED EMBODIMENTS

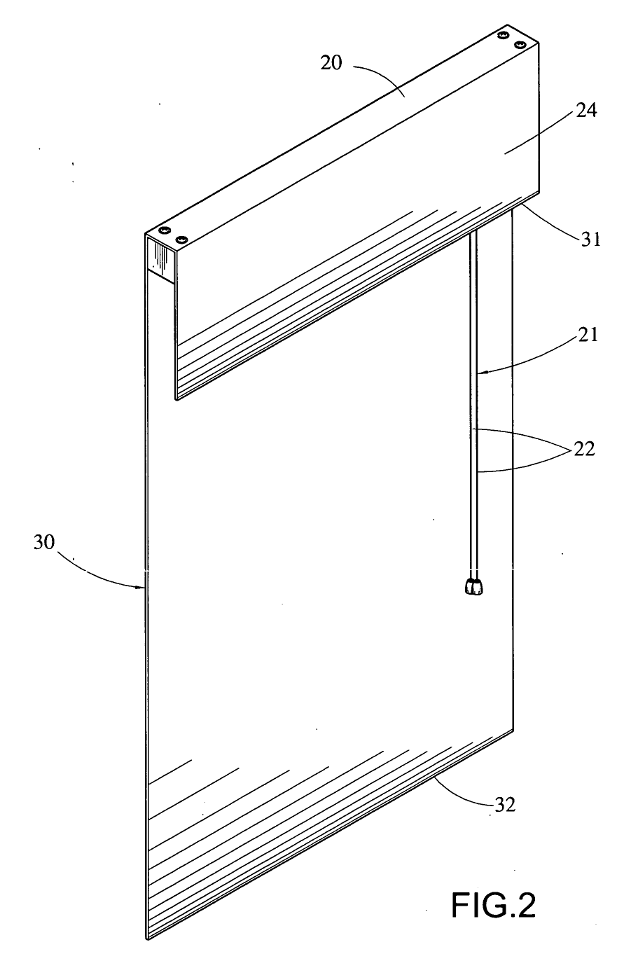

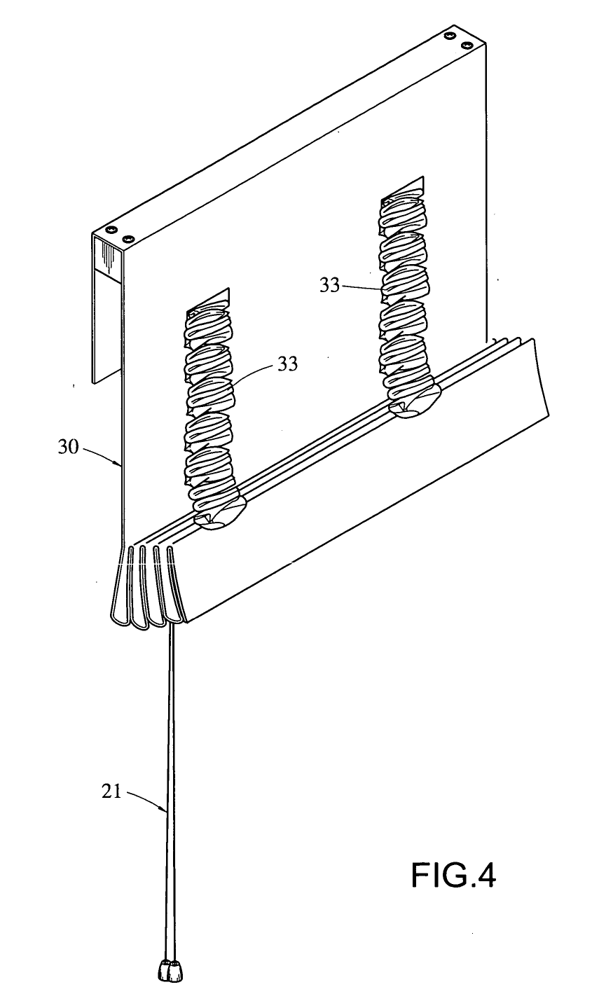

Referring to FIGS. 2, 3 and 4, there is shown a roll-up blind constructed in accordance with the invention. The blind comprises a headrail 20 coupled to a window, a brake mechanism proximate the headrail 20, the brake mechanism comprising two tension pulley sets 25 and a brake 26 adjacent one tension pulley set 25, and a cord 21 including two portions 22 at one end passing one tension pulley set 25 and the brake 26, and two portions 23 at the other end. In operation, a user can pull either portion 22 to lower or lift the blind. The blind further comprises a shade cloth 30 having a lower end 32 and an upper end 31 stretched over the headrail 20 in which a portion stretched over the headrail 20 is formed as a decorative member 24 terminated at the upper end 31. The decorative member 24 is used to cover an upper portion of the headrail 20 and a joining portion of the headrail 20 and the shade cloth 30. Two cord covers 33 are formed of a soft material (e.g., yarn). Each cord cover 33 has a top end 34 and a bottom end 35 both coupled to the shade cloth 30. As such, the shade cloth 30 can be drawn up or lowered as the cord covers 33 lifts or lowers. A clip ring 36 is formed at the bottom end 35 of either cord cover 33. The portions 23 at the other end of the cord 21 pass the top ends 34 to couple to the clip rings 36. The cord covers 33 can have one of a plurality of different colors. Preferably, the color of the cord covers 33 is matched with that of the shade cloth 30 for aesthetic purposes. A plurality of positioning elements 37 are equally spaced apart longitudinally on the cord cover 33. The positioning elements 37 are stitched to the cord cover 33 and the shade cloth 30 so that a lifting or lowering movement of the cord covers 33 can move the shade cloth 30 the same. Hence, a lift of the portions 23 at the other end by pulling the cord 21 will cause the positioning elements 37 other than the topmost one to draw up toward the topmost positioning element 37 (see FIG. 4). The shade cloth 30 is wrinkled upwardly. Also, the cord covers 33 are contracted together to form aesthetic members.

The portions 23 at the other end are concealed in the cord covers 33 and the cord covers 33 are confined by the positioning elements 37. As such, a dangerous ring will not be formed by the cord 21 and the cord covers 33 in operation. This is a highly safe scheme.

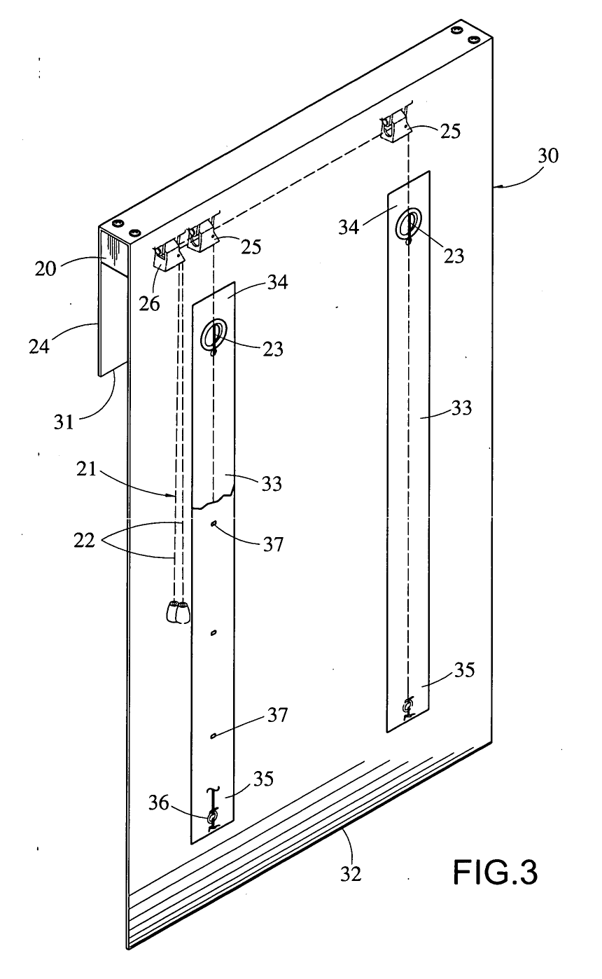

In operation, a user may pull the cord 21 to fully lower the shade cloth 30 (see FIG. 3), fully draw up the shade cloth 30 (see FIG. 4), or stop the shade cloth 30 at a desired position between that shown in FIG. 3 and that shown in FIG. 4 by means of the tension pulley sets 25 and the brake 26.

While the invention herein disclosed has been described by means of specific embodiments, numerous modifications and variations could be made thereto by those skilled in the art without departing from the scope and spirit of the invention set forth in the claims.

1. A roll-up blind, comprising:
a headrail;
a brake mechanism proximate the headrail;
a cord having one end passed the brake mechanism to form an operable portion;
a shade cloth coupled to the headrail, the shade cloth having a lower end coupled to the other end of the cord; and
a plurality of cord covers formed on the shade cloth to cover the other end of the cord,
whereby pulling the operable portion of the cord will cause the shade cloth to wrinkle upwardly and the cord covers to contract together.

2. The roll-up blind of claim 1, further comprising a plurality of spaced apart positioning elements formed longitudinally on each cord cover, whereby a lifting or lowering movement of the cord covers by pulling the operable portion of the cord will draw up the positioning elements other than the topmost positioning element toward the topmost positioning element.

3. The roll-up blind of claim 1, wherein each of the cord covers is formed of a soft material.

4. The roll-up blind of claim 2, wherein the positioning elements are formed by stitching to the cord cover and the shade cloth so that a lifting or lowering movement of the cord covers is able to move the shade cloth the same.
